(19) United States
(12) Patent Application Publication
(10) Pub. No.: US 2006/0275604 A1
(43) Pub. Date: Dec. 7, 2006

(54) Abrasion-resistant wires, fibres and filaments

(76) Inventors: Florence Clement, Yzeron (FR); Franck Bouquerel, Lyon (FR); Gilles Roberts, Irigny (FR); Jean-Francois Thierry, Francheville (FR)

Correspondence Address: Jean Louis Seugnet;Rhodia Inc, Legal Department CN 7500, 8 Cedar Brook Drive, Cranbury, NJ, 08512-7500, US

(21) Appl. No.: 10/565,870

(22) PCT Filed: Jul. 23, 2004
(86) PCT No.: PCT/FR04/01974

§ 371 Date: Aug. 9, 2006

(30) Foreign Application Priority Data
Jul. 25, 2003 (FR) 03/09155

(51) Int. Cl. D04H 1/00; D02G 3/00; F16J 15/20

(52) U.S. Cl. 428/364; 428/365; 442/357

(57) ABSTRACT

The invention relates to wires, fibres and filaments having improved resistance to abrasion, which are suitable, for example, for the production of felts for papermaking machines. In particular, the invention relates to polyamide- or polyester-based wires, fibres and filaments.

The present invention relates to yarns, fibres or filaments which have an improved abrasion resistance and which can be used in particular for the preparation of felts for paper-making machines. It relates more particularly to yarns, fibres or filaments based on polyamide or on polyester.

The properties which spun articles have to exhibit differ according to their use. Mention may be made, among these properties, for example, of mechanical strength, transparency, gloss, whiteness, ability to be dyed, shrinkage, water-retaining capacity, flame retardancy, stability and longevity towards heat, and the like. One property which may be required, in particular for applications in industrial fields or “technical yarn” fields, is abrasion resistance.

This is the case, for example, with felts, which are composite structures comprising a stack of woven layers (obtained from continuous monofilaments) and of nonwoven layers (obtained from cut fibres), the layers generally being assembled by needling. The increase in the abrasion resistance generally makes it possible to increase the lifetime of the articles manufactured from the yarns, fibres or filaments. In the case of felts for paper-making machines, which are produced from synthetic fibres, this property has become critical for numerous reasons: replacement of chemical bleaching agents by solid particles, for example of calcium carbonate, increase in production rates or in operating temperatures of the paper-making machines, which stress the felts in a more critical way.

This is also the case, for example, with carpets, including fitted carpets, ropes and belts, nets or fabrics used in the field of silk screen printing or filtration. In this case, the mechanical stresses from rubbing or abrasion on these articles are such that the property of abrasion resistance directly characterizes their lifetime.

A known solution for improving the abrasion resistance of spun articles is to increase the degree of polymerization of the synthetic material from which they are manufactured. Thus it is that fibres manufactured from thermoplastic resins with an increasingly high molecular mass are being developed. This increase in the molecular mass is reflected by an increase in the melt viscosity of the polymer. The spinning of fibres with a very high melt viscosity requires the use of very high spinning pressures and/or of very high spinning temperatures, which can cause damage to the polymer. A possible alternative, disclosed in U.S. Pat. No. 5,234,644 and U.S. Pat. No. 5,783,501, consists in producing yarns or fibres with conventional molecular masses and in then increasing, a posteriori (on the fibre, in the case of U.S. Pat. No. 5,234,644, or on the felt, in the case of U.S. Pat. No. 5,783,501), the viscosity of the polymers. However, there are limits to this solution. Thus, this adds an additional stage in the process and requires the use of chemical solutions comprising catalysts.

Another known solution consists in spinning polymers of high molecular mass but for which a reduction in the melt viscosity is sought. This can be obtained by virtue of the use of polymers comprising star macromolecular chains. The polymers comprising such star macromolecular chains are, for example, disclosed in the documents FR 2 743 077, FR 2 779 730, U.S. Pat. No. 5,959,069, EP 0 632 703, EP 0 682 057 and EP 0 832 149. These compounds are known for exhibiting an improved fluidity with respect to linear polyamides with the same molecular mass. However, the yarns, fibres or filaments obtained from these polymers do not exhibit good abrasion resistance properties.

Another solution for improving the abrasion resistance of the articles produced from fibres consists in using articles exhibiting three-dimensional crimping, as disclosed in Patent CA 2 076 726.

It is also known, to improve the abrasion resistance of spun articles, to introduce particles of nanometric size, such as silica or a montmorillonite, into the yarns. These articles are disclosed in particular in the document WO 01/02629.

It is an object of the present invention to provide another solution for the production of spun articles with high abrasion resistance.

To this end, the invention provides abrasion-resistant yarns, fibres and filaments obtained from a composition comprising a polymer matrix, the polymer matrix consisting of a polycondensate composed of:
30 to 100 mol % (limits included) of macromolecular chains corresponding to the following formula (I):
   R₃—(X—R₂—Y)ₙ—X-A-R₁-A-X—(Y—R₂—X)ₘ—R₃ (I)
0 to 70 mol % (limits included) of macromolecular chains corresponding to the following formula (II):
   R₄—[Y—R₂—X]ₚ—R₃ (II)
in which:
—X—Y— is a radical resulting from the condensation of two reactive functional groups F₁ and F₂ such that
   F₁ is the precursor of the —X— radical and F₂ is the precursor of the —Y— radical, or vice versa,
   the F₁ functional groups cannot react with one another by condensation,
   the F₂ functional groups cannot react with one another by condensation,
A is a covalent bond or an aliphatic hydrocarbonaceous radical which can comprise heteroatoms and which comprises from 1 to 20 carbon atoms,
R₂ is a branched or unbranched, aliphatic or aromatic, hydrocarbonaceous radical comprising from 2 to 20 carbon atoms,
R₃ or R₄ represents hydrogen, a hydroxyl radical or a hydrocarbonaceous radical,
R₁ is a linear or cyclic, aromatic or aliphatic, hydrocarbonaceous radical which comprises at least 2 carbon atoms and which can comprise heteroatoms,
n, m and p each represent a number between 50 and 500, preferably between 100 and 400.

All the known polycondensation functional groups can be used in the context of the invention for F₁ and F₂.

According to a specific embodiment of the invention, the polymer matrix is a polyamide A1 composed of:
30 to 100 mol % (limits included) of macromolecular chains corresponding to the following formula (I):
   R₃—(X—R₂—Y)ₙ—X-A-R₁-A-X—(Y—R₂—X)ₘ—R₃ (I)
0 to 70 mol % (limits included) of macromolecular chains corresponding to the following formula (II):
   R₄—[Y—R₂—X]ₚ—R₃ (II)
   in which:
Y is the 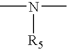
radical when X represents the 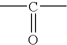
radical,
Y is the 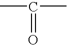
radical when X represents the 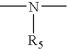
radical,
A is a covalent bond or an aliphatic hydrocarbonaceous radical which can comprise heteroatoms and which comprises from 1 to 20 carbon atoms,
R₂ is a branched or unbranched, aliphatic or aromatic, hydrocarbonaceous radical comprising from 2 to 20 carbon atoms,
R₃ or R₄ represents hydrogen, a hydroxyl radical or a hydrocarbonaceous radical comprising a 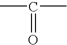
or 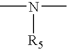
group,
R₅ represents hydrogen or a hydrocarbonaceous radical comprising from 1 to 6 carbon atoms,
R₁ is a linear or cyclic, aromatic or aliphatic, hydrocarbonaceous radical which comprises at least 2 carbon atoms and which can comprise heteroatoms,
n, m and p each represent a number between 50 and 500, preferably between 100 and 400.
   According to another specific embodiment of the invention, the polymer matrix of the invention consists of a polyester A2 composed of:
30 to 100 mol % (limits included) of macromolecular chains corresponding to the following formula (I):
   R₃—(X—R₂—Y)ₙ—X-A-R₁-A-X—(Y—R₂—X)ₘ—R₃ (I)
0 to 70 mol % (limits included) of macromolecular chains corresponding to the following formula (II):
   R₄—[Y—R₂—X]ₚ—R₃ (II)
   in which:
Y is the —O— radical when X represents the 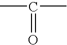
radical,
Y is the 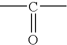
radical when X represents the —O— radical,
A is a covalent bond or an aliphatic hydrocarbonaceous radical which can comprise heteroatoms and which comprises from 1 to 20 carbon atoms,
R₂ is a branched or unbranched, aliphatic or aromatic, hydrocarbonaceous radical comprising from 2 to 20 carbon atoms,
R₃ or R₄ represents hydrogen, a hydroxyl radical or a hydrocarbonaceous radical comprising a 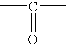
—O— group,
R₁ is a linear or cyclic, aromatic or aliphatic, hydrocarbonaceous radical which comprises at least 2 carbon atoms and which can comprise heteroatoms,
n, m and p each represent a number between 50 and 500, preferably between 100 and 400.

The polymer matrix of the invention can also be a copolyesteramide.

Advantageously, m, n and p are between 100 and 400, in particular between 100 and 300. m, n and p can, for example, be between 120 and 240. It should be noted that the values of m and n can be equal. The values m, n and p can also be equal.

Advantageously, R₂ is a pentamethylene radical.

The polyamide A1 or the polyester A2 of the invention advantageously comprises at least 45 mol %, preferably at least 60 mol %, more preferably still at least 80 mol % of macromolecular chains corresponding to the formula (I).

The polyamide A1 or the polyester A2 of the invention advantageously exhibits a number-average molecular mass at least equal to 10 000 g/mol, preferably at least equal to 20 000 g/mol, more preferably at least equal to 25 000 g/mol.

The term “number-average molecular mass of the polyamide A1 or of the polyester A2” is understood to mean the number-average molecular mass weighted by the molar fractions of the two types of macromolecular chains of the formulae (I) and (II).

The yarns, fibres or filaments of the invention, comprising the polyamide A1 and/or the polyester A2 in their polymer matrix, exhibit good abrasion resistance properties. They are in particular suitable for the manufacture of felts for paper-making machines. The use of the polyamide A1 or of the polyester A2 makes it possible to spin at a lower temperature and/or at a reduced pressure with respect to the conditions which would be necessary in the absence of the polyamide A1 or of the polyester A2. It is thus possible either to obtain yarns which exhibit better abrasion resistance or to obtain fibres with similar properties with a less restrictive process (in particular in operating temperature or in spinning pressure).

The yarns, fibres and filaments according to the invention can comprise all the additives commonly used with such polymers, for example heat stabilizers, UV stabilizers, catalysts, pigments and dyes, or antibacterial agents.

According to a specific embodiment of the invention, the polyamide A1 or the polyester A2 is obtained by copolymerization from a mixture of monomers comprising:
a) a difunctional compound, the reactive functional groups of which are chosen from amines, carboxylic acids, alcohols, and their derivatives, the reactive functional groups being identical,
b) monomers of following general formulae (IIIa) and (IIIb), in the case of the polyamide A1 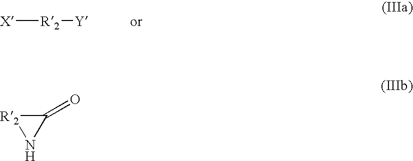
b′) monomers of following general formulae (IIIa′) and (IIIb′), in the case of the polyester A2 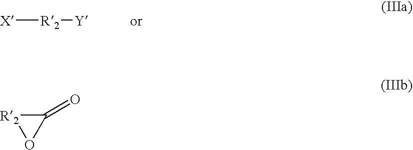
   in which:
R′₂ represents a substituted or unsubstituted, aliphatic, cycloaliphatic or aromatic, hydrocarbonaceous radical which comprises from 2 to 20 carbon atoms and which can comprise heteroatoms,
Y′ is an amine radical when X′ represents a carboxyl radical, or Y′ is a carboxyl radical when X′ represents an amine radical, in the case of the polyamide A1,
Y′ is a hydroxyl radical when X′ represents a carboxyl radical, or Y′ is a carboxyl radical when X′ represents a hydroxyl radical, in the case of the polyester A2.

The term “carboxylic acid” or “carboxyl radical” in the present invention is understood to mean carboxylic acids and their derivatives, such as acid anhydrides, acid chlorides, esters, nitrites, and the like. The term “amine” is understood to mean amines and their derivatives.

The monomers of formula (IIIa) or (IIIb) are preferably the monomers of polyamides of the polyamide-6, polyamide-11 or polyamide-12 type, and the like. Mention may be made, as examples of monomers of formula (IIIa) or (IIIb) which may be suitable in the context of the invention, of caprolactam, 6-aminocaproic acid, lauryllactam, and the like. A mixture of different monomers may be involved.

Mention may be made, as examples of monomers of formula (IIIa′) or (IIIb′) which may be suitable in the context of the invention, of caprolactone, δ-valerolactone, 4-hydroxybenzoic acid, and the like.

The mixture of monomers can also comprise a monofunctional monomer used conventionally in the production of polymers as chain-limiting agent.

The mixture of monomers can also comprise catalysts.

During the operation of mixing the monomers, the various compounds of the mixture can be introduced in the dry form, advantageously with a moisture level of less than 0.2%, preferably of less than 0.1%, and a compound capable of catalysing the polycondensation of the polyamide or the polyester can be added, preferably in a concentration by weight of between 0.001% and 1%. The moisture level can be measured according to the Karl Fischer method.

These catalysts, preferably introduced in a concentration by weight of between 0.001% and 1%, can be chosen from phosphorus-comprising compounds, for example phosphoric acid or tris(2,4-di(tert-butyl)phenyl)phosphite (sold by Ciba under the reference Irgafos 168), pure or as a mixture with N,N-hexamethylenebis(3,5-di(tert-butyl)-4-hydroxyhydrocinnamamide) (sold by Ciba under the reference Irganox B 1171).

Advantageously, the compound a) represents between 0.05 and 1 mol % with respect to the number of moles of monomers of type b) or b′), preferably between 0.1 and 0.5 mol %.

In the case of the polyamide A1, the copolymerization of the monomers is carried out under conventional polymerization conditions for polyamides obtained from lactams or from amino acids.

In the case of the polyester A2, the copolymerization of the monomers is carried out under conventional polymerization conditions for polyesters obtained from lactones or from hydroxy acids.

The polymerization can comprise a finishing stage in order to obtain the desired degree of polymerization.

According to another specific embodiment of the invention, the polyamide A1 or the polyester A2 is obtained by melt blending, for example using an extrusion device, a polyamide of the type of those obtained by polymerization of lactams and/or amino acids or a polyester of the type of those obtained by polymerization of lactones and/or hydroxy acids and a difunctional compound, the reactive functional groups of which are chosen from amines, alcohols, carboxylic acids and their derivatives, the reactive functional groups being identical. The polyamide is, for example, polyamide-6, polyamide-11, polyamide-12, and the like. The polyester is, for example, polycaprolactone, poly(pivalolactone), and the like.

The difunctional compound is added directly to the polyamide or the polyester in a molten medium.

Advantageously, the difunctional compound represents between 0.05 and 2% by weight with respect to the weight of polyamide or of polyester.

During the operation of blending the polyester or the polyamide with the difunctional compound, the various compounds of the blend can be introduced in the dry form, advantageously with a moisture level of less than 0.2%, preferably of less than 0.1%, for example into an extrusion device, and a compound capable of catalysing the polycondensation of the polyamide or of the polyester can be added, preferably in a concentration by weight of between 0.001% and 1%. This compound can be chosen from phosphorus-comprising compounds, for example phosphoric acid or tris(2,4-di(tert-butyl)phenyl)phosphite (sold by Ciba under the reference Irgafos 168), pure or as a mixture with N,N-hexamethylenebis(3,5-di(tert-butyl)-4-hydroxyhydrocinnamamide) (sold by Ciba under the reference Irganox B 1171). This compound can be added in the form of a powder or in the form concentrated in a polyamide matrix (master batch). The blending of the various compounds can be carried out in a single- or twin-screw extrusion device.

The difunctional compound of the invention is preferably represented by the formula (IV):
X″-A-R₁-A-X″ (IV)

in which X″ represents an amine radical, a hydroxyl radical or a carboxyl group or their derivatives,

R₁ and A are as described above.

Mention may be made, as examples of X″ radicals, of a primary amine radical, a secondary amine radical, and the like.

The difunctional compound can be a dicarboxylic acid. Mention may be made, as examples of diacids, of adipic acid, which is the preferred acid, decanedioic acid, sebacic acid, dodecanedioic acid or phthalic acids, such as terephthalic acid or isophthalic acid. It can be a mixture comprising by-products resulting from the manufacture of adipic acid, for example a mixture of adipic acid, of glutaric acid and of succinic acid.

The difunctional compound can be a diamine. Mention may be made, as examples of diamines, of hexamethylenediamine, methylpentamethylenediamine, 4,4′-diaminodicyclohexylmethane, butanediamine or metaxylylenediamine.

The difunctional compound can be a dialcohol. Mention may be made, as examples of dialcohols, of 1,3-propanediol, 1,2-ethanediol, 1,4-butanediol, 1,5-pentanediol, 1,6-hexanediol and polytetrahydrofuran.

The difunctional compound can be a mixture of a diamine and of a dialcohol.

In the case of the polyamide A1, the reactive functional groups of the difunctional compound are generally amines or carboxylic acids or derivatives.

In the case of the polyester A2, the reactive functional groups of the difunctional compound are generally alcohols or carboxylic acids or derivatives.

Preferably, the difunctional compound is chosen from adipic acid, decanedioic acid, sebacic acid, dodecanedioic acid, terephthalic acid, isophthalic acid, hexamethylenediamine, methylpentamethylenediamine, 4,4′-diaminodicyclohexylmethane, butanediamine, metaxylylenediamine, 1,3-propanediol, 1,2-ethanediol, 1,4-butanediol, 1,5-pentanediol, 1,6-hexanediol and polytetrahydrofuran.

According to another specific embodiment of the invention, the polyamide A1 or the polyester A2 is obtained by melt blending, for example using an extrusion device, a polyamide of the type of those obtained by polymerization of lactams and/or amino acids or a polyester of the type of those obtained by polymerization of lactones and/or hydroxy acids with a compound of formula (V)
G-R-G (V)

in which

R is substituted or unsubstituted, linear or cyclic, aromatic or aliphatic, hydrocarbonaceous radical which can comprise heteroatoms,

G is a functional group or a radical which can selectively react either with the amine reactive functional groups or with alcohol reactive functional groups or with the carboxylic acid reactive functional groups of the polyamide or of the polyester, to form covalent bonds. The polyamide is, for example, polyamide-6, polyamide-11 or polyamide-12. The polyester is, for example, polycaprolactone or poly(pivalolactone).

The compound of formula (V) is added directly to the polyamide or the polyester in a molten medium.

Advantageously, the compound of formula (V) represents between 0.05 and 2% by weight with respect to the weight of polyamide or of polyester.

During the operation of blending the polyester or the polyamide with the compound of formula (V), the various compounds of the blend can be introduced in the dry form, advantageously with a moisture level of less than 0.2%, preferably of less than 0.1%, for example into an extrusion device, and a compound capable of catalysing the polycondensation of the polyamide or of the polyester can be added, preferably in a concentration by weight of between 0.001% and 1%. This compound can be chosen from phosphorus-comprising compounds, for example phosphoric acid or tris(2,4-di(tert-butyl)phenyl)phosphite (sold by Ciba under the reference Irgafos 168), pure or as a mixture with N,N-hexamethylenebis(3,5-di(tert-butyl)-4-hydroxyhydrocinnamamide) (sold by Ciba under the reference Irganox B 1171). This compound can be added in the form of a powder or in the form concentrated in a polyamide matrix (master batch). The blending of the various compounds can be carried out in a single- or twin-screw extrusion device.

Any coupling agent for polymer chains or extending agent for polymer chains known to a person skilled in the art, generally comprising two identical functional groups or two identical radicals and selectively reacting either with the amine reactive functional groups or with the alcohol reactive functional groups or with the carboxylic acid reactive functional groups of the polyamide or of the polyester, to form covalent bonds, can be used as compound of formula (V).

In the case of the production of polyamide A1, the compound (V) can, for example, selectively react with the amine functional groups of the polyamide into which it is introduced. This compound will not react with the acid functional groups of the polyamide in this case.

The spun articles, yarns, fibres or filaments are produced according to conventional spinning techniques starting from a composition comprising a polymer matrix comprising at least the polyamide A1 or the polyester A2 described above. The spinning can be carried out immediately after the polymerization of the matrix, the latter being in the molten form. It can be carried out starting from a granule comprising the composition.

The spun articles according to the invention can be subjected to any treatment which can be carried out in stages subsequent to the spinning stage. They can in particular be drawn, texturized, crimped, heated, twisted, dyed, sized, cut, and the like. These additional operations can be carried out continuously and can be incorporated after the spinning device or can be carried out batchwise. The list of the operations subsequent to the spinning has no limiting effect.

The invention also relates to articles comprising yarns, fibres and/or filaments as described above.

The yarns, fibres or filaments according to the invention can be used in the woven, knitted or nonwoven form.

The fibres according to the invention are suitable in particular for the manufacture of felts for paper-making machines, in particular for the non-woven layers of the felts for paper-making machines.

The yarns, fibres or filaments according to the invention can also be used as yarns for fitted carpets.

They can also be used, in particular the monofilaments, for the production of fabrics in the field of silk screen printing, for print transfers, or in the field of filtration.

The yarns, fibres or filaments of the invention, and in particular the multistrands, can also be used in the manufacture of ropes, in particular climbing ropes, or of belts, in particular conveyor belts.

Finally, the yarns of the invention can be used for the manufacture of nets, in particular fishing nets.

Other details or advantages of the invention will become more clearly apparent in the light of the examples given below purely by way of indication.

Characterization Tests:

Content of End Groups

The contents of acid [COOH] and amine [NH₂] end groups are quantitatively determined by potentiometry.

Calculation of the Molar Levels of Chains Corresponding to the Formulae (I) and (II) Described Above for the Polymers of the Invention

In Examples 1 to 3 below, the polymers are composed of a mixture of:
linear chains corresponding to the formula (II) and comprising 2 different ends per chain (COOH and NH₂)
linear chains corresponding to the formula (I) and comprising 2 identical ends per chain (2 times COOH).

In this specific case, R₃ is the hydroxyl radical and R₄ is the hydrogen radical (as defined in the document).

The molar level of chains corresponding to the formulae (I) and (II) are estimated according to the following formulae:
molar level (I)=([COOH]−[NH₂])/([COOH]+[NH₂])
molar level (II)=2*[NH₂]/([COOH]+[NH₂])

Calculation of the Number-Average Molecular Mass

The number-average molecular mass [Mₙ]is estimated according to the following formulae:
in the Comparative Examples A and the examples of the invention, which correspond to linear polymers (the term “linear polymer” is understood to mean a polymer composed of macromolecular chains each comprising 2 ends), use is made of the conventional formula [Mₙ]=2×10⁺⁶/([NH₂]+[COOH])
in Comparative Examples B, the polymer is a blend of linear chains (2 ends per polymer chain) and of star chains comprising 4 branches (4 ends per star polymer chain); use is thus made of the formula established in Patent WO 97/24388: [Mₙ]=1×10⁺⁶/(Co+[NH₂]), where Co=([COOH]+[NH₂])/4 represents the molar concentration of the tetrafunctional compound constituting the core unit of the stars (all the functional groups of the core unit are identical: —COOH).

In all these formulae, the concentrations [COOH], [NH₂] and Co are expressed in μmol/g, the mass [Mₙ] being expressed in g/mol.

Standardization of the Pressure Drop in the Pack (Spinneret Head)

In the various examples described below, a pressure drop (expressed in bars) is measured when passing through the pack (spinneret head) composed of filtration elements and of capillaries. However, depending on the nature of the polymer, it is necessary to adjust the temperature of the pack and of the polymer. This has the effect of changing the value of the pressure drop. It is well known that the melt viscosity of the polymers, or in this case the pressure drop, varies with the temperature according to a law of Arrhenius type which makes it possible, for example, from the experimental values (temperature T₁ and pressure drop ΔP₁), to estimate the value of the pressure drop ΔP₂ at any another temperature T₂. Furthermore, this calculation can be extended to the cases where the two spinning conditions additionally correspond to different flow rates (when the variation in absolute value |ΔQ/Q| is less than 50%), respectively Q₁ and Q₂:
ΔP₂=Q₂/Q₁×ΔP₁×Exp[E×(1/T₂−1/T₁)/R]
In this formula, T₁ and T₂ are expressed in degrees Kelvin, E is the activation energy, expressed in J/mol, and R is the perfect gas constant (R=8.31 J/mol/K).
In this formula, the flow rate Q can be measured in a completely equivalent way at several levels. The simplest is to measure the count (the unit being the dtex, equal to the mass in g of 10 000 m of multifilament).
Under these conditions, Q is easily obtained by writing:
Q=t*v/10 000
In this formula, the flow rate Q is expressed in g/min, the count t is expressed in dtex=g/10 000 m and the rate v is expressed in m/min.
As all the tests were carried out with the same delivery rate, it is consequently sufficient to replace, in the preceding formula, the ratio of the flow rates Q₂/Q₁ by the ratio of the counts t₂/t₁.
In the case of the polyamide, the activation energy E is equal to 60 kJ/mol (M. I. Kohan, Nylon Plastics, page 140, published by John Wiley & Sons Inc., 1973).
In order to compare the different spinning conditions (T₁, ΔP₁) of the examples described in detail below, a standardization is carried out, that is to say that the values of pressure drops ΔP₁ measured at T₁ (variable from one test to another) for a flow rate of Q₁ (product of the count, in dtex, by the rate, in m/min, which are variable from one test to another) are all corrected to the same temperature T₂, chosen to be equal to 250° C., and to the same flow rate Q₂ (equivalent to 200 dtex at 800 m/min) according to the preceding formula. The ΔP₂ values of the various examples can consequently be compared with one another.

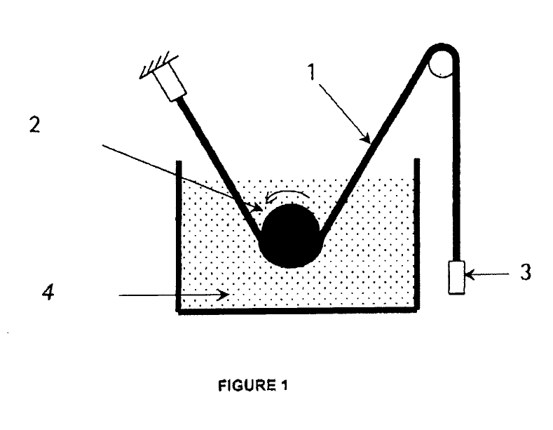

Abrasion Resistance Test
The equipment used for the abrasion resistance test is represented diagrammatically in FIG. 1. The reference 1 represents the yarn, the reference 2 a ceramic bar, the reference 3 a load of 3 g and the reference 4 water.
In this test, already described in the literature (“Abrasion Resistant PA Fiber” lecture, Man-Made Fiber Congress, Dornbirn, September 2002), a unitary filament is subjected to a pretension of 3 g. The yarn is immersed in a bath of water at 23° C. The filament rubs against a ceramic bar with a diameter of 10 mm, sold by Rothschild for the FFAB (Felt Fibre Abrasion Tester) test, with surface roughnesses of Ra=1.7 μm, Rz=8.9 μm and Rmax=11.3 μm. The bar is rotated at 300 revolutions/minute with a contact angle of the yarn on the bar (tension rail) of 90°.

Before the test, the filament is first of all desized beforehand for 1 hour in a Soxhlet assembly in petroleum ether and is then conditioned in a water bath at 25° C. for 24 h.

The total number of revolutions before failure of the filament is recorded. This number is divided by the unit count of the strand in order to dispense with the count of the strand, which can vary from one test to another.

In total, the experiment is repeated 30 times and the mean of the results is taken.

### EXAMPLES

### Comparative Examples A=Polyamide-6

Synthesis

Polyamides-6, referred to as A1, A2, A3 and A4, are synthesized. They exhibit the following characteristics:

| | [NH₂]* | [COOH]* | [Mₙ]** |
|---|---|---|---|
| Polyamide-6 | μmol/g | μmol/g | g/mol |
| A1 | 44 | 53 | 20 600 |
| A2 | 31 | 51 | 24 360 |
| A3 | 36 | 39 | 26 600 |
| A4 | 35 | 35 | 28 570 |

*measurements carried out a posteriori on the yarn
**[Mₙ] = 2 × 10⁺⁶/([NH₂] + [COOH])

Spinning

These polyamides-6 are spun under the following conditions:
twin-screw extruder,
temperature adjusted in order to obtain a satisfactory spinnability,
spinneret with 10 holes,
air cooling,
delivery rate of 800 m/min,
overall count of the order of 200 to 240 dtex.

Under these temperature and flow rate conditions, a pressure drop is observed when passing through the pack (spinneret block comprising the filtration elements and the capillaries). The crude values (temperature, count, pressure drop) and the restandardized values, that is to say corrected to a constant temperature (250° C.) and a constant flow rate (corresponding to a count of 200 dtex for a delivery rate of 800 m/min), are specified in the following table. The restandardization is carried out in accordance with the formula described above.

| | T₁ | ΔP₁ | t₁ | ΔP₂ |
|---|---|---|---|---|
| Polyamide-6 | ° C. | bar | dtex | bar |
| A1 | 248 | 123 | 209 | 112 |
| A2 | 264 | 143 | 240 | 171 |
| A3 | 301 | 125 | 243 | 350 |
| A4 | 307 | 151 | 240 | 488 |

Drawing

The draw ratio is adjusted so as to obtain, after drawing, the desired level of elongation at break: approximately 80%. The yarn thus obtained is still composed of 10 filaments.

### Comparative Examples B=Polymer Comprising Star Macromolecular Chains

Synthesis

The star polyamides B1, B2 and B3 are obtained by copolymerization from caprolactam in the presence of approximately 0.5 mol % of 2,2,6,6-tetra(β-carboxyethyl)-cyclohexanone according to a process disclosed in the document FR 2 743 077. They exhibit the following characteristics:

| Star | [NH₂]* | [COOH]* | [Mₙ]** |
|---|---|---|---|
| polyamide-6 | μmol/g | μmol/g | g/mol |
| B1 | 15 | 169 | 18 690 |
| B2 | 30 | 58 | 27 080 |
| B3 | 22 | 79 | 27 720 |

*measurements carried out a posteriori on the yarn
**[Mₙ] = 1 × 10⁺⁶/(([COOH] − [NH₂])/4 + [NH₂])

Spinning

The yarn thus obtained is composed of 10 filaments, the overall count of which is of the order of 240 dtex.

As above, these polymers are spun under temperature and flow rate conditions such that a good spinnability is obtained. Under these conditions, a pressure drop is observed and is restandardized to constant temperature and flow rate, as above.

| Star | T₁ | ΔP₁ | t₁ | ΔP₂ |
|---|---|---|---|---|
| polyamide-6 | ° C. | bar | dtex | bar |
| B1 | 232 | 58 | 240 | 30 |
| B2 | 287 | 148 | 242 | 304 |
| B3 | 281 | 130 | 239 | 235 |

Drawing

The draw ratio is adjusted so as to obtain, after drawing, the desired level of elongation at break. It is still composed of 10 filaments.

### Examples 1-3

### According to the Invention

Synthesis

These polymers are obtained by polycondensation of caprolactam in the presence of adipic acid. They exhibit the following characteristics:

| | Content | | | | | |
|---|---|---|---|---|---|---|
| | of adipic | | | Molar | Molar | |
| | acid | [NH₂]* | [COOH]* | level | level | [Mₙ]** |
| Polyamide | mol % | μmol/g | μmol/g | (I) | (II) | g/mol |
| 1 | 0.6 | 8 | 122 | 88 | 12 | 15 360 |
| 2 | 0.27 | 12 | 62 | 68 | 32 | 27 030 |
| 3 | 0.18 | 15.5 | 50.5 | 53 | 47 | 30 300 |

*measurements carried out a posteriori on the yarn
**[Mₙ] = 2 × 10⁺⁶/([NH₂] + [COOH])

Spinning

The yarns thus obtained are still composed of 10 filaments, the overall count of which is of the order of 200 dtex.

As above, these polymers are spun under temperature and flow rate conditions such that a good spinnability is obtained. Under these conditions, a pressure drop is observed and is restandardized at constant temperature and flow rate, as above.

| | T₁ | ΔP₁ | t₁ | ΔP₂ |
|---|---|---|---|---|
| Polyamide | ° C. | bar | dtex | bar |
| 1 | 225 | 67 | 212 | 32 |
| 2 | 277 | 128 | 220 | 229 |
| 3 | 298 | 191 | 212 | 574 |

Drawing

The draw ratio is adjusted so as to obtain, after drawing, the desired level of elongation at break. It is still composed of 10 filaments. The unit count is 9.9 dtex.

### Example 4

### Measurement of the Abrasion Resistance

The characteristics in terms of fluidity and of abrasion resistance of Comparative Examples A, Comparative Examples B and the examples in accordance with the invention are presented in Table 1 below.

TABLE 1

| | ΔP_{standardized} | [Mₙ] | Abrasion |
|---|---|---|---|
| | (bar) | (g/mol) | (cycles/dtex) |
| Comparative Ex. A1 | 112 | 20 600 | 185 |
| Comparative Ex. A2 | 171 | 24 360 | 211 |
| Comparative Ex. A3 | 350 | 26 600 | 283 |
| Comparative Ex. A4 | 488 | 28 570 | 335 |
| Comparative Ex. B1 | 30 | 18 690 | 130 |
| Comparative Ex. B2 | 304 | 27 080 | 214 |
| Comparative Ex. B3 | 235 | 27 720 | 182 |
| Ex 2 | 229 | 27 030 | 272 |
| Ex 3 | 574 | 30 300 | 385 |

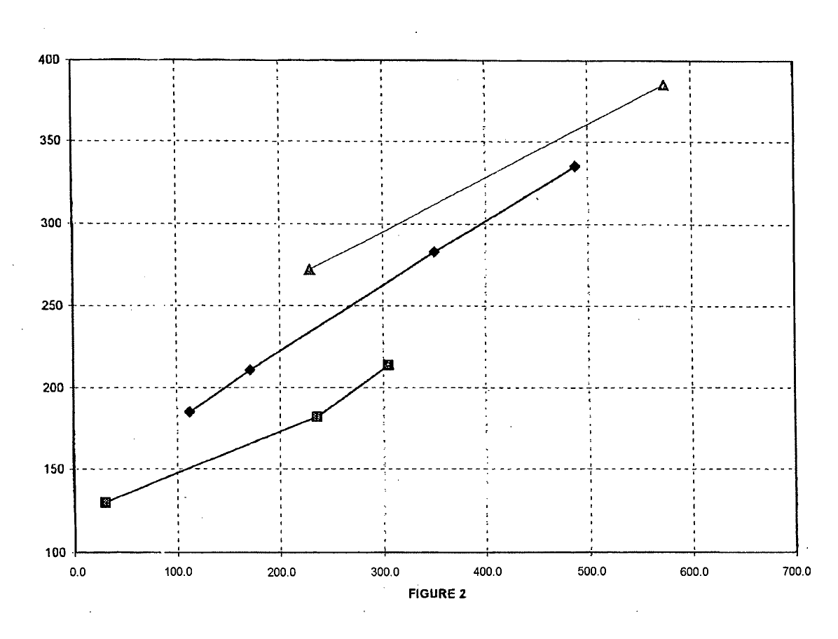

FIG. 2 is a graph which represents, on the abscissa, the pressure drop when passing through the pack (expressed in bar) and, on the ordinate, the abrasion resistance (expressed in cycles/dtex). In this FIG. 2, the polymers A are represented by diamonds, the polymers B are represented by squares and the polymers 2-3 are represented by triangles.
It is apparent that, for the polymers tested, the abrasion resistance is directly related to the pressure drop (itself directly related to the molecular mass). In other words, the improvement in this use property is only possible at the expense of the increase in the pressure drop, that is to say the deterioration in the processability. In point of fact, this pressure drop (or melt viscosity) cannot be infinitely increased without bringing about thermal decomposition of the polymer, for example.
With respect to the abrasion resistance/pressure drop correlation of Comparative Examples A, it is apparent that Comparative Examples B, obtained here by blending with star polymers comprising 4 branches, are reflected by a deterioration in the compromise.
On the other hand, the examples in accordance with the invention are reflected by an improvement in the compromise, that is to say by the possibility of obtaining higher abrasion resistances for the same processability.

1-21. (canceled)

22. Abrasion-resistant yarns, fibres and filaments obtained from a composition comprising a polymer matrix, the polymer matrix consisting of a polycondensate composed of:
30 to 100 mol % (limits included) of macromolecular chains corresponding to the following formula (I):
R₃—(X—R₂—Y)ₙ—X-A-R₁-A-X—(Y—R₂—X)ₘ—R₃ (I)
0 to 70 mol % (limits included) of macromolecular chains corresponding to the following formula (II):
R₄—[Y—R₂—X]ₚ—R₃ (II)
in which:
—X—Y— is a radical resulting from the condensation of two reactive functional groups F₁ and F₂ such that
F₁ is the precursor of the —X— radical and F₂ is the precursor of the —Y— radical, or vice versa,
the F₁ functional groups cannot react with one another by condensation,
the F₂ functional groups cannot react with one another by condensation,
A is a covalent bond or an aliphatic hydrocarbonaceous radical which can comprise heteroatoms and having from 1 to 20 carbon atoms,
R₂ is a branched or unbranched, aliphatic or aromatic, hydrocarbonaceous radical having from 2 to 20 carbon atoms,
R₃ or R₄ represents hydrogen, a hydroxyl radical or a hydrocarbonaceous radical,
R₁ is a linear or cyclic, aromatic or aliphatic, hydrocarbonaceous radical having at least 2 carbon atoms and, optionally, heteroatoms, and
n, m and p each represent a number between 50 and 500.

23. The yarns, fibres and filaments according to claim 22, wherein the polymer matrix consists of a polyamide A1 composed of:
30 to 100 mol % (limits included) of macromolecular chains corresponding to the following formula (I):
R₃—(X—R₂—Y)ₙ—X-A-R₁-A-X—(Y—R₂—X)ₘ—R₃ (I)
0 to 70 mol % (limits included) of macromolecular chains corresponding to the following formula (II):
R₄—[Y—R₂—X]ₚ—R₃ (II)
in which:
Y is the 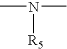
radical when X represents the 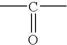
radical,
Y is the 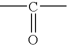
radical when X represents the 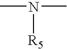
radical,
A is a covalent bond or an aliphatic hydrocarbonaceous radical having from 1 to 20 carbon atoms, and, optionally, heteroatoms,
R₂ is a branched or unbranched, aliphatic or aromatic, hydrocarbonaceous radical having from 2 to 20 carbon atoms,
R₃ or R₄ represents hydrogen, a hydroxyl radical or a hydrocarbonaceous radical having a 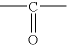
or 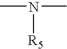
group,
R₅ represents hydrogen or a hydrocarbonaceous radical having from 1 to 6 carbon atoms,
R₁ is a linear or cyclic, aromatic or aliphatic, hydrocarbonaceous radical having at least 2 carbon atoms and, optionally, heteroatoms, and
n, m and p each represent a number between 50 and 500.

24. The yarns, fibres and filaments according to claim 22, wherein the polymer matrix consists of a polyester A2 composed of:
30 to 100 mol % (limits included) of macromolecular chains corresponding to the following formula (I):
R₃—(X—R₂—Y)ₙ—X-A-R₁-A-X—(Y—R₂—X)ₘ—R₃ (I)
0 to 70 mol % (limits included) of macromolecular chains corresponding to the following formula (II):
R₄—[Y—R₂—X]ₚ—R₃ (II)
in which:
Y is the —O— radical when X represents the 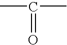
radical,
Y is the 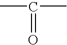
radical when X represents the —O— radical,
A is a covalent bond or an aliphatic hydrocarbonaceous radical having from 1 to 20 carbon atoms, and, optionally, heteroatoms,
R₂ is a branched or unbranched, aliphatic or aromatic, hydrocarbonaceous radical having from 2 to 20 carbon atoms,
R₃ or R₄ represents hydrogen, a hydroxyl radical or a hydrocarbonaceous radical having a 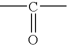
or —O— group,
R₁ is a linear or cyclic, aromatic or aliphatic, hydrocarbonaceous radical having at least 2 carbon atoms, and, optionally, heteroatoms, and
n, m and p each represent a number between 50 and 500.

25. The yarns, fibres and filaments according to claim 24, wherein n, m and p are between 100 and 300.

26. The yarns, fibres and filaments according to claim 23, wherein the polyamide A1 or the polyester A2 has at least 45 mol %, preferably at least 60 mol %, of macromolecular chains corresponding to the formula (I).

27. The yarns, fibres and filaments according to claim 23, wherein the polyamide A1 or the polyester A2 exhibits a number-average molecular mass at least equal to 25 000 g/mol.

28. The yarns, fibres and filaments according to claim 22, wherein R₂ is a pentamethylene radical.

29. The yarns, fibres and filaments according to claim 23, wherein the polyamide A1 or the polyester A2 is obtained by copolymerization from a mixture of monomers comprising:
a) a difunctional compound, the reactive functional groups of which are chosen from amines, carboxylic acids, alcohols, and their derivatives, the reactive functional groups being identical,
b) monomers of following general formulae (IIIa) and (IIIb), in the case of the polyamide A1 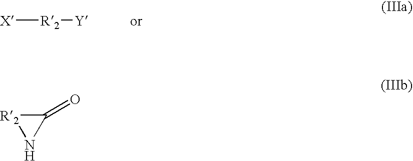
b′) monomers of following general formulae (IIIa′) and (IIIb′), in the case of the polyester A2 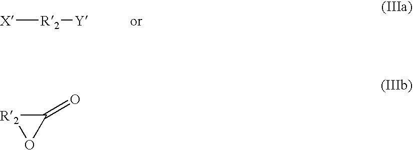
in which:
R′₂ represents a substituted or unsubstituted, aliphatic, cycloaliphatic or aromatic, hydrocarbonaceous radical having from 2 to 20 carbon atoms and, optionally, heteroatoms,
Y′ is an amine radical when X′ represents a carboxyl radical, or Y′ is a carboxyl radical when X′ represents an amine radical, in the case of the polyamide A1, and Y′ is a hydroxyl radical when X′ represents a carboxyl radical, or Y′ is a carboxyl radical when X′ represents a hydroxyl radical, in the case of the polyester A2.

30. The yarns, fibres and filaments according to claim 29, wherein the compound a) represents between 0.05 and 1 mol % with respect to the number of moles of monomers of type b) or b′).

31. The yarns, fibres and filaments according to claim 23, wherein the polyamide A1 or the polyester A2 is obtained by melt blending a polyamide of the type of those obtained by polymerization of lactams and/or amino acids or a polyester of the type of those obtained by polymerization of lactones and/or hydroxy acids with a difunctional compound, whose reactive functional groups are amines, alcohols, carboxylic acids or their derivatives, the reactive functional groups being identical.

32. The yarns, fibres and filaments according to claim 31, wherein the difunctional compound represents between 0.05 and 2% by weight with respect to the weight of polyamide or of polyester.

33. The yarns, fibres and filaments according to claim 29, wherein the difunctional compound is represented by the formula (IV):
X″-A-R₁-A-X″ (IV)
in which X″ represents an amine radical, a hydroxyl radical, a carboxyl group or their derivatives.

34. The yarns, fibres and filaments according to claim 29, wherein the difunctional compound is adipic acid, decanedioic acid, sebacic acid, dodecanedioic acid, terephthalic acid, isophthalic acid, hexamethylenediamine, methylpentamethylenediamine, 4,4′-diaminodicyclohexylmethane, butanediamine, metaxylylenediamine, 1,3-propanediol, 1,2-ethanediol, 1,4-butanediol, 1,5-pentanediol, 1,6-hexanediol or polytetrahydrofuran.

35. The yarns, fibres and filaments according to claim 23, wherein the polyamide A1 or the polyester A2 is obtained by melt blending a polyamide obtained by polymerization of lactams and/or amino acids or a polyester obtained by polymerization of lactones and/or hydroxy acids with a compound of formula (V)
G-R-G (V)
in which
R is substituted or unsubstituted, linear or cyclic, aromatic or aliphatic, hydrocarbonaceous radical, optionally having heteroatoms, and
G is a functional group or a radical which can selectively react either with the amine reactive functional groups or with alcohol reactive functional groups or with the carboxylic acid reactive functional groups of the polyamide or of the polyester, to form covalent bonds.

36. The yarns, fibres and filaments according to claim 35, wherein the compound of formula (V) represents between 0.05 and 2% by weight with respect to the weight of polyamide or of polyester.

37. An article comprising yarns, fibres and/or filaments as defined in claim 22.

38. The article according to claim 37, being a felt for a paper-making machine.

39. The article according to claim 37, being a carpet, or a fitted carpet.

40. The article according to claim 37, being a rope or a belt.

41. The article according to claim 37, being a fabric for print transfer or for filtration.

42. The article according to claim 37, being a net.
